(19) United States
(12) Patent Application Publication
(10) Pub. No.: US 2004/0070504 A1
(43) Pub. Date: Apr. 15, 2004

(54) Semi-covert RFID enabled containers

(76) Inventors: Brian W. Brollier, Cincinnati, OH (US); Thomas Wisner, Bradenton, FL (US)

Correspondence Address: Christopher Nicastri, International Paper Company, 1422 Long Meadow Road, Tuxedo, NY, 10987, US

(21) Appl. No.: 10/269,712

(22) Filed: Oct. 14, 2002

(51) Int. Cl. G08B 13/14

(52) U.S. Cl. 340/572.8

(57) ABSTRACT

A semi-covert RFID enabled container comprises a container blank and an RF transponder positioned on the container blank so that it is not visible from the exterior of the container when the container is erected. The container blank includes a plurality of interconnected panels and a plurality of flaps. The flaps and panels define an overlapping area on the blank where the flaps and panels overlap when the container is erected. The RF transponder is positioned on the blank in the overlapping area. A method of forming a semi-covert RFID enabled container comprises providing a container blank having flaps, panels, and an overlapping area, and coupling the RF transponder to the blank in the overlapping area. The method may also include erecting the container, where the erecting step includes folding and attaching the flaps of the blank.

### FIELD OF THE INVENTION

The claimed invention relates to wireless communication systems. In particular, the invention relates to a container that incorporates RFID components in a semi-covert manner.

### BACKGROUND

Radio frequency identification (RFID) technology has been used for wireless automatic identification. An RFID system typically includes a transponder, an antenna, and a transceiver with a decoder. The transponder, which typically includes a radio frequency integrated circuit, and antenna may be positioned on a substrate, such as an inlet or tag. The antenna serves as a pipeline between the circuit and the transceiver. Data transfer between the transponder and transceiver is wireless. RFID systems may provide non-contact, non-line of sight communication.

RF transponder “readers” utilize an antenna as well as a transceiver and decoder. When a transponder passes through an electromagnetic zone of a reader, the transponder is activated by the signal from the antenna. The transceiver decodes the data on the transponder and this decoded information is forwarded to a host computer for processing. Readers or interrogators can be fixed or handheld devices, depending on the particular application.

Several different types of transponders are utilized in RFID systems, including passive, semi-passive, and active transponders. Each type of transponder may be read only or read/write capable. Passive transponders obtain operating power from the radio frequency signal of the reader that interrogates the transponder. Semi-passive and active transponders are powered by a battery, which generally results in a greater read range. Semi-passive transponders may operate on a timer and periodically transmit information to the reader. Transponders may also be activated when they are read or interrogated by a reader. Transponders may control their output, which allows them to activate or deactivate apparatus remotely. Active transponders can initiate communication, whereas passive and semi-passive transponders are activated only when they are read by another device first. Active transponders can supply instructions to a machine and then the machine may then report its performance to the transponder. Multiple transponders may be located in a radio frequency field and read individually or simultaneously. Sensors may be coupled to the transponders to sense an environmental condition.

### SUMMARY

According to one embodiment of the invention, an RFID enabled container comprises a container blank having defined thereon an overlapping area and an RF transponder positioned on the blank in the overlapping area. The container blank has a plurality of interconnected panels and a plurality of flaps for use in erecting a container having an opening bounded by the plurality of interconnected panels. The flaps are configured to form the blank into a three-dimensional shape and at least partially close the opening by overlapping one another or the panels. The flaps and panels define an overlapping area on the blank where the plurality of flaps and panels overlap when the container blank is erected. The RF transponder is positioned on the blank such that the transponder is not visible from the exterior of the container when the container blank is erected.

According to another aspect of the invention, a method of forming an RFID enabled container comprises providing a container blank having defined thereon an overlapping area and coupling an RF transponder to the blank in the overlapping area. The providing step includes providing a container blank having a plurality of interconnected panels and a plurality of flaps for erecting a container having an opening bounded by the plurality of interconnected panels. The flaps are configured to form the blank into a three-dimensional shape and at least partially close the opening by overlapping at least one of one another and the panels. The flaps and panels define an overlapping area on the blank where the plurality of flaps and panels overlap when the container is erected.

### BRIEF DESCRIPTION OF THE DRAWING FIGURES

FIG. 1 is a plan view of an external surface of a container blank having an RFID transponder positioned in an overlapping area on the blank;

FIG. 2 is a plan view of an internal surface of the container blank of FIG. 1;

FIG. 3 is a cut-away perspective view of the container blank of FIGS. 1 and 2, erected into a three-dimensional container;

FIG. 4 is a plan view of an external surface of an alternative embodiment of a container blank having an RFID processsor positioned in an overlapping area on the blank;

FIG. 5 is a plan view of an internal surface of the container blank of FIG. 4;

FIG. 6 is a cut-away perspective view of the container blank of FIGS. 4 and 5, erected into a three-dimensional container;

FIG. 7 is a plan view of an external surface of an alternative embodiment of a three-sided container blank having an RFID transponder positioned in an overlapping area on the blank;

FIG. 8 is a plan view of an internal surface of the container blank of FIG. 7;

FIG. 9 is a perspective view of the container blank of FIGS. 7 and 8 partially erected into a three-dimensional container;

FIG. 10 is a plan view of an external surface of an alternative embodiment of a lid container blank having an RFID transponder positioned in an overlapping area on the blank;

FIG. 11 is a plan view of an internal surface of the blank of FIG. 10; and

FIG. 12 is a perspective view of the container blank of FIGS. 10 and 11, erected into a three-dimensional container lid.

### DETAILED DESCRIPTION

The invention relates to a container blank 10 that includes an RF transponder 12 for use in radio frequency identification. The blank 10 has an external surface 14 and an internal surface 16. The external surface 14 is the surface that is positioned on the outside of the container 20 when the blank 10 is erected into a container 20, while the internal surface 16 is the surface that is positioned on the inside of the container 20 when the blank 10 is erected into a container 20. The container blank 10 is erected into a container 20 for housing a product. A container 20 will typically be constructed in a manner to have flaps which form the bottom and top of the container 20. In some designs, a separate lid is used where no top flaps are utilized around the top of the container.

A typical container blank 10 includes a plurality of interconnected panels 22 and a plurality of flaps 24 that are connected to the panels 22. The panels 22 surround an opening 26 in the container 20. The panels 22 and flaps 24 are connected to one another along score lines 28, so that the panels 22 and flaps 24 may be easily folded along the score lines 28. A majority of the external surface 14 and internal surface 16 will be visible from the exterior and interior of the container 20, respectively, except for those areas on the blank that are overlapped by other flaps or panels to obscure the surface below the overlapped flaps or panels. Depending on the design, the container 10 may have an open end, which is an end that is not fixedly secured closed when the container 10 is constructed and housing a product. An example of a container that has an open end is a small appliance box, such as the container shown in FIG. 6, which can be opened by the consumer to inspect the small appliance inside the box and then is reclosable after the appliance has been inspected. This is in contrast to a shipping box, such as the containers shown in FIGS. 3 and 9, which will be fixedly secured closed by tape or adhesive so that the top of the box may not be easily opened and reclosed.

When the container 20 is assembled, the flaps 24 and panels 22 overlap one another in particular overlapping areas 42, 44 on the blank 10. These overlapping areas 42, 44 have a variety of different shapes depending on the shape and construction of the blank 10 and container 20. Two different types of overlapping areas are typically provided on a blank depending on whether the container has an open end. One type of overlapping area 42 is not visible when the container is open. The other type of overlapping area 44 is visible when the container is open or closed. The first type of overlapping area, area 42, is typically more covert than the second type of overlapping area, area 44, because the first type of area is never visible when the container is erected, regardless of whether the top of the container 20 is open or closed.

The present invention utilizes the overlapping areas 42, 44 and positions an RF transponder 12 in the overlapping areas 42, 44 so that the transponder 12 is semi-covert in nature. The transponder 12 is semi-covert in that it is visible when the container blank is not erected, but not easily visible when the container is erected and/or closed. It is desirable to position an RF transponder on a container 20 for use in such things as inventory tracking and identification. It is also desirable to position the RF transponder 12 on the container 20 so that the transponder 12 may not be easily tampered with or removed by a user.

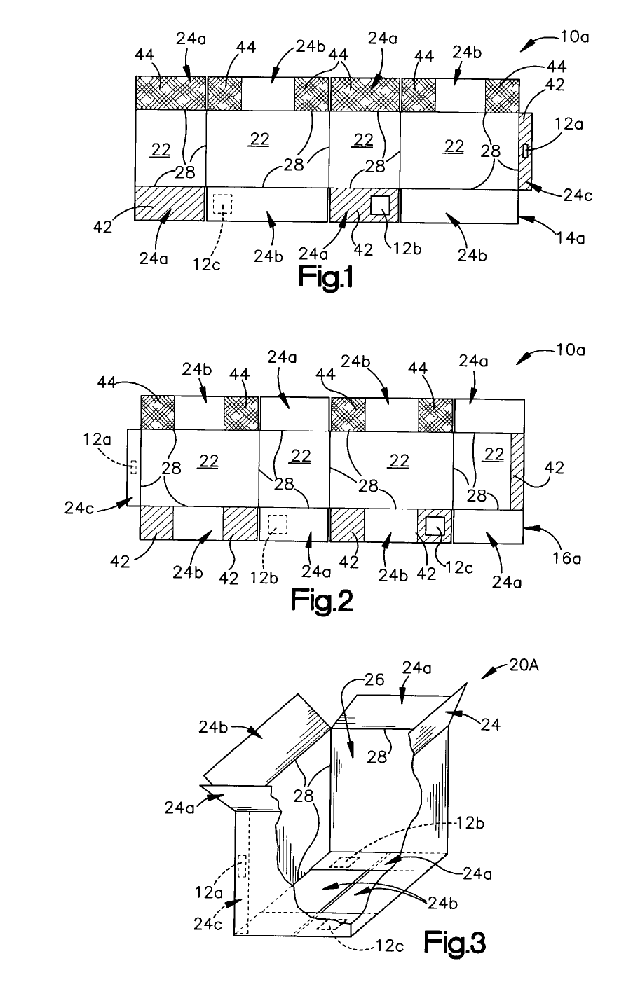

Several examples of container blanks 10 and erected containers 20 are depicted in FIGS. 1-12. The depicted container blanks 10 and containers 20 are for illustration purposes only, the invention not being limited to a particular container shape or configuration. The invention is applicable to any type of container that has an overlapping area 42, 44 when the container 20 is erected.

The term “RF transponder,” as utilized herein, refers to an RF processor 36 that is associated with an antenna 32. The term “processor” refers generally to a computer that processes or stores information, such as a computer chip. The processor may include a semiconductor circuit having logic, memory, and RF circuitry. The computer chip may be a silicon-based chip, a polymer-based chip, or other chips that are known today or will be developed in the future. In addition, the term “processor” includes new “chipless” technology, such as that manufactured by Checkpoint; “flip chips” that include bridging connections built directly into the chip; or other chips that include substrates that act like interposers.

The processor 36 may have an onboard antenna or may utilize an external antenna. Where an RF processor having an onboard antenna is utilized, the RF transponder 12 is the processor. The processor 36 may be positioned on a substrate 34, for ease in attachment to a surface 14, 16 of the container 20. Alternatively, the RF processor 36 may be directly applied to a surface 14, 16 of the container 20, without a substrate.

Where the RF processor 36 utilizes an external antenna 32, the antenna 32 may be positioned on the transponder 12 or on the surface 14, 16 of the container blank 10. When the antenna 32 is positioned on the transponder 12, the transponder 12 preferably includes a substrate 34 and the antenna 32 and processor 36 are positioned on the substrate 34 and electrically coupled to one another. The antenna 32 may be an inductive or a capacitive antenna and the processor 36 may be an inductive or a capacitive processor. When the antenna 32 is positioned on the surface 14, 16 of the container blank 10, the processor 36 may be positioned on a substrate 34 or may be independent of a substrate 34. When independent of a substrate, the antenna 36 may be positioned on the surface 14, 16 of the container blank 10 utilizing any known technique, such as printing a conductive ink, sputter coating a conductive material, and hot foil stamping, among other known antenna depositing techniques. The processor 36 may be coupled to the antenna 32 by leads, connectors, interposers, or other known techniques for coupling a processor to an antenna, if so desired.

The substrate 34 of the transponder 12 may be a paper or polymeric material, among other known materials. The substrate 34 may include a pressure sensitive adhesive (not shown), or other attachment medium, for ease in attaching the transponder 12 to the surface 14, 16 of the container blank 10, as is typical with a label. Alternatively, the substrates 34 may be applied using glues, hot melts, water activated adhesives, or other adhering mediums. The substrates 34 may be applied to the container blanks with an automatic labeling device during the assembly of a corrugated blank into a container blank 10.

Referring to the figures, FIGS. 1-3 show a blank 10a and a container 20a in the form of a box. FIG. 1 shows the external surface 14a of the blank 10a, FIG. 2 shows the internal surface 16a of the blank 10a, and FIG. 3 shows the blank 10a after it has been erected into a box 20a. The blank 10a includes interconnected body panels 22, end flaps 24a, side flaps 24b, and an assembly flap 24c, which are separated from one another along score lines 28. The flaps 24a, 24b, 24c and panels 22 are foldable along the score lines 28. The end and side flaps 24a, 24b are connected to the top and bottom edges of the panels 22, while the assembly flap 24c is connected to the side edge of one of the body panels.

In assembling the container blank 10a in FIGS. 1 and 2 to form the box of FIG. 3, the free ends of the container blank 10a are brought together and joined by the assembly flap 24c, which is attached to the internal surface 16a of an adjoining panel of the blank 10a using tape, glue, staples or other known attachment mediums. The joined container blank then has a three-dimensional shape and may be assembled into a finished container 20a. The finished container is assembled by folding the end flaps 24a toward each other along the score lines 28 until they form a flat surface relative to one another, and folding the side flaps 24b along the score lines 28 over the folded end flaps to form a flat surface. The flaps 24 may be secured to one another utilizing an adhesive, a tape, or other adhering medium if its desired to fixedly attach the flaps to one another. It is generally preferred to fixedly attach the flaps on the bottom of the container 20a to form a receptacle for storing products in the container 20a. The flaps 24a, 24b around the top edge may or may not be fixedly secured in place depending on the application. The adhering medium may be applied to the flaps 24a, 24b either prior to or after assembling the blank 10a into a three-dimensional shape. When an adhesive is used, the end and side flaps 24a, 24b are fixed to one another. Alternatively, when tape is applied to the side flaps 24b, the end flaps 24a are held inside the container 20a, but may not be attached to the side flaps 24b, depending on the shape of the flaps.

When the blank 10a is erected, the end and side flaps 24a, 24b overlap one another to close the openings 26 in the box 20a, while the assembly flap 24c overlaps one of the panels 22. The areas 42, 44 where the flaps 24a, 24b, 24c overlap one another and the panels 22 is shown by cross-hatching in FIGS. 1 and 2. The overlapping areas 42 positioned around the bottom flaps 24a, 24b and on the side of the panel where the assembly flap 24c attaches are typically not visible when the top of the container 20a is open or closed. The overlapping areas 44 positioned around the top flaps 24a, 24b are not visible when the container 20b is closed, but are visible when the top flaps 24a, 24b are open.

The RF transponder 12 may be positioned at a number of different places in the overlapping areas 42, 44, as shown in FIGS. 1-3. In one embodiment, an RF transponder 12a may be positioned on the external surface 14a of the assembly flap 24c so that when the assembly flap 24c is fixed to an adjacent panel 22, the RF transponder 12a is positioned between the assembly flap 24c and the internal surface 16a of the adjacent panel. This positioning of the transponder 12a will typically result in covert placement, since the assembly flap 24c is normally fixed to the adjacent panel by glue or staples. When the blank 10a is in its cut, but unassembled form, the RF transponder 12a will be visible. Once the blank 10a is at least partially constructed such that the flap 24c is adhered to adjacent panel 22, the RF transponder is completely covert provided that the RF transponder is smaller in size than the flap 24c. It is not necessary that the blank 10a be fully assembled into a box to provide this covert placement. Advantageously, with this embodiment, the box blank 10a in its partially assembled position can be shipped to the customer as a flat blank so that the customer can finish the assembly of the box by folding the upper and lower flaps. Thus, even when the blank 10a is partially assembled, the RF transponder 12a is completely covert in this embodiment.

Alternatively, an RF transponder 12b may be positioned on the external surface 14a of one of the end flaps 24a. In this position, the transponder 12b is not visible when the box 20a is erected because the transponder 12b will be hidden between the end flap 24a and one of the side flaps 24b.

In another embodiment, an RF transponder 12c is positioned on an internal surface 16a of one of the side flaps 24b of the blank 10a. When the container 20a is erected, the transponder 12c will be positioned in the center of the overlapped portion created between the side flap 24b and the overlying end flap 24a. For example, if the box is 12 inches wide by 18 inches long, and the bottom side flaps 24b are 6 inches wide, the transponder's center will be 3 inches from each of two adjacent edges of one of the 6×12 inch side flaps.

The transponder 12 may be positioned in any of the overlapping areas 42, 44 in FIGS. 1 and 2 so that when the container 20a is closed, the transponder 12 will not be accessible by the user.

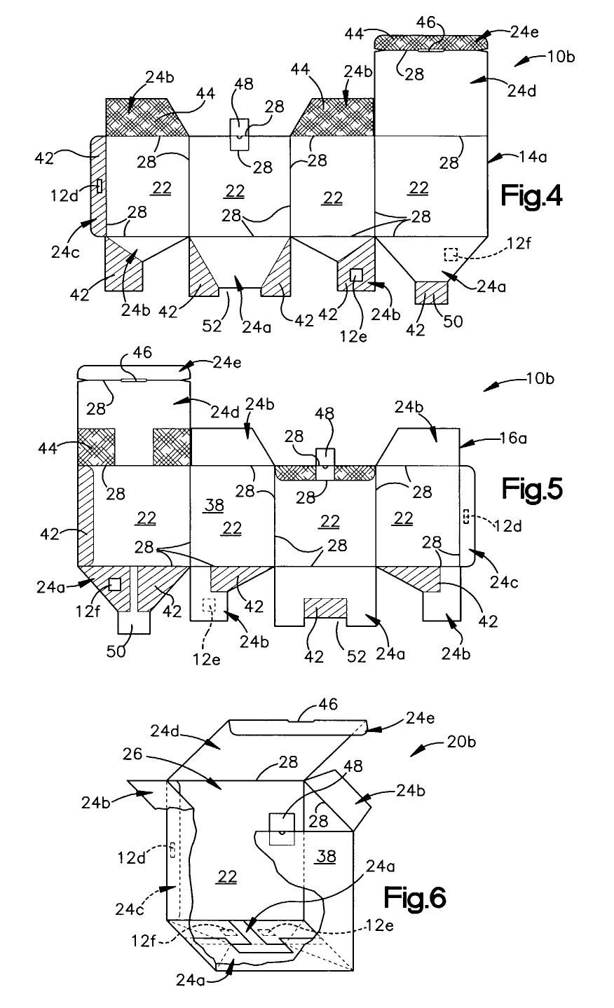

Referring to FIGS. 4-6, a blank 10b and container 20b having a tuck in lid are depicted. FIG. 4 shows the external surface 14b of the blank 10b, FIG. 5 shows the internal surface 16b of the blank 10b, and FIG. 6 shows the blank 10b after it has been erected into a box 20b. The container blank 10b includes four interconnected body panels 22. An assembly flap 24c is attached to the side of one of the body panels 22. A top flap 24d is attached to the top edge of one of the body panels, and includes a front flap 24e attached at the free end of the top flap 24d. The front flap 24e is the flap that is “tucked in” to the container 20b behind the front container panel 38 when the top flap 24d is closed. A slot 46 may be positioned on the top flap 24d along a portion of the score line 28 between the top flap 24d and the front flap 24e. A securing tab 48 may be inserted into the slot 46 once the top flap 24d is closed to secure the lid in a closed position. Two side flaps 24b are positioned along the top edge of the panels and two side flaps 24a are positioned along the bottom edge of the body panels. Two end flaps 24a are also positioned along the bottom edge of the body panels. One of the end flaps 24a includes a tongue 50 and the other includes a recess 52 for receiving the tongue 50.

In assembling the container blank 10b into a container 20b, the free ends of the container blank 10b are joined together by the assembly flap 24c, which is attached to an adjacent panel of the blank 10b using an adhering medium, such as adhesive, tape, or staples. Once the assembly flap 24c is attached to the adjacent panel, the blank 10b takes on a three-dimensional shape. The container 20b is formed by first folding the bottom end flap 24a having the recess 52 toward the opening 26 of the container 20b along the score line 28, then folding the bottom side flaps 24b toward each other along the score lines 28, and then folding the bottom end flap 24a having the tongue 50 in toward the other end flap 24a. The tongue 50 on the end flap 24a is inserted through the recess 52 in the other bottom end flap 24a and through an opening formed between the side flaps 24b and the bottom end flap 24a so that the end flap 24a having the tongue 50 overlaps the side flaps 24b and the other end flap 24a. The respective flaps 24a, 24b interlock with one another so that an adhering medium is generally not necessary.

The flaps 24a, 24b attached along the top edge of the panels may be assembled by folding in the side flaps 24b along the score lines 28 toward one another, folding in the top flap 24d along the score line 28 over the side flaps 24b, and tucking the front flap 24e behind the front container panel 38. The tab 48 on the panel 38 may then be inserted into the slot 46 on the top flap 24d to secure the top flap 24d in position on the container 20b. An adhering medium may be positioned along the edges of the top flap 24d to fix the top flap 24d to the panels 22, such as a piece of tape. In addition, an adhering medium may be utilized to secure the flaps 24a, 24b positioned around the bottom of the container 20b to one another, such as tape or an adhesive.

When the blank 10b is erected into a container 20b, the end and side flaps 24a, 24b overlap one another to close the openings 26 in the box 20b, while the assembly flap 24c overlaps one of the panels. The areas 42, 44 where the flaps 24a, 24b, 24c, 24d, 24e overlap one another and the panel 38 is shown by cross-hatching in FIGS. 4 and 5. The overlapping areas 42 positioned around the flaps 24a, 24b on the bottom and on the side of the panel where the assembly flap 24c attaches are typically not visible when the top flap 24d is open or closed. The overlapping areas 44 positioned around the top flap 24d and the top end flaps 24a are not visible when the container 20b is closed, but are visible when the top flap 24d is open.

The RF transponder may be positioned in any number of positions in the overlapping areas 42, 44, as shown in FIGS. 4-6. In one embodiment, an RF transponder 12d may be positioned on the external surface 14b of the assembly flap 24c so that when the assembly flap 24c is fixed to an adjacent panel, the RF transponder 12d is positioned between the assembly flap 24c and the internal surface 16b of the adjacent panel. This positioning of the transponder 12d will typically result in covert placement, since the assembly flap 24c is conventionally glued to the adjacent panel.

Alternatively, an RF transponder 12e may be positioned on the external surface 14b of one of the end flaps 24a. In this position, the transponder 12e is not visible when the box 20b is erected because the transponder 12e will be hidden between an end flap 24a and one of the side flaps 24b.

In another embodiment, an RF transponder 12f is positioned on an internal surface 16b of one of the side flaps 24b of the blank 10b. As shown in FIG. 5, the transponder 12f is positioned on the end flap 24a having the tongue 50. When the container 20b is erected, the transponder 12f will be positioned between the end flap 24a having the tongue 50 and the overlying end flap 24a having the recess 52.

As with prior embodiments, the transponder 12 may be positioned in any of the overlapping areas 42, 44 so that when the container 20b is closed, the transponder 12 will not be accessible by the user.

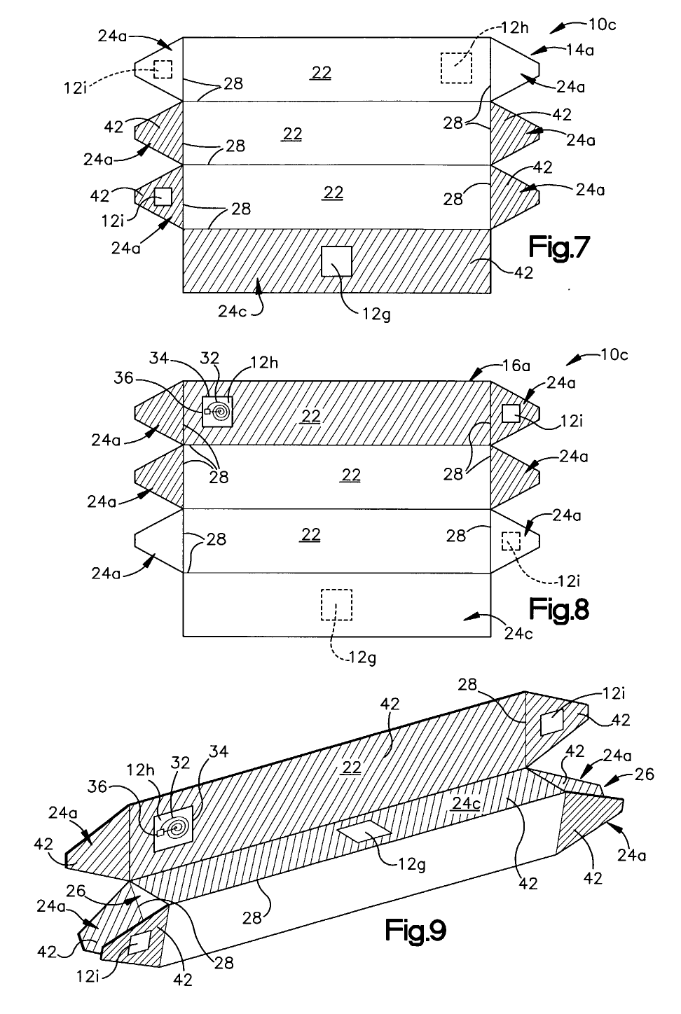

Referring to FIGS. 7-9, a three-sided tube container 20c and blank 10c is depicted. FIG. 7 shows the external surface 14c of the blank 10c, FIG. 8 shows the internal surface 16c of the blank 10c, and FIG. 9 shows the blank 10c after it has been erected into a three-dimensional container shape, but with an opening 26 at the ends. The container blank 10c includes three interconnected body panels 22, an assembly flap 24c, and end flaps 24a. The assembly flap 24c is attached to a side edge of one of the body panels, and the end flaps 24a are attached to the ends of the body panels 22. Score lines 28 are positioned between the panels 22 and flaps 24a, 24c.

In order to assemble the container blank 10c into a three-sided tube container 20c, the free ends of the blank 10c are brought together by folding the panels 22 and assembly flap 24c along the score lines 28 to form a triangular shape, with the assembly flap 24c overlapping one of the panels. The assembly flap 24c may be fixed to the panel 22 that it overlaps using a conventional adhering medium, such as adhesive, tape, staples, or other know adhering mediums. The container 20c may be constructed by folding the ends flaps 24a along the score lines 28 inwardly to close the openings 26 at the ends of the container 20c. One end flap is folded in first, followed by a second that covers the first end flap, and a third that covers the second end flap. The flaps may be secured together utilizing an adhering medium. Alternatively, the outermost end flap may be secured to the panels utilizing tape, so that the innermost end flaps 24a are not fixed relative to one another inside the container 10c.

When the blank 10c is erected into a container 20c, the end flaps 24a overlap one another to close the openings 26 in the box 20c, while the assembly flap 24c overlaps one of the panels 22. The areas 42, 44 where the flaps 24a, 24c overlap one another and the panels 22 is shown in cross-hatching in FIGS. 7 and 8. The overlapping areas 42, 44 positioned on the end flaps 24a and on the side of the panel 22 where the assembly flap 24c attaches are typically not visible when the container 20c is closed.

In FIGS. 7 to 9, the RF transponder is shown positioned in several different places in the overlapping area 42, 44. In one embodiment, an RF transponder 12g is positioned on the external surface 14c of the assembly flap 24c so that when the assembly flap 24c is attached to the panel 22 that it overlies, the RF transponder 12g is positioned between the assembly flap 24c and the internal surface 16c of the adjacent panel 22. This positioning of the transponder 12g will typically result in covert placement, since the assembly flap 24c is conventionally glued to the adjacent panel 22.

In a similar embodiment, an RF transponder 12h is positioned on the internal surface 16c of the body panel 22 that is positioned over the assembly flap 24c when the container 20c is erected. In this position, the RF transponder 12g is located between the assembly flap 24c and the internal surface 16c of the adjacent panel 22. This positioning of the transponder 12g will also result in covert placement, since the assembly flap 24c is conventionally glued to the adjacent panel 22.

Alternatively, an RF transponder 12i may be positioned on the external or internal surfaces 14c, 16c of one of the end flaps 24a. In this position, the transponder 12i is covertly positioned when the box 20c is erected because the transponder 12i will be hidden between the end flaps 24a. The transponder 12 may be positioned in locations other than those shown in FIGS. 7-9.

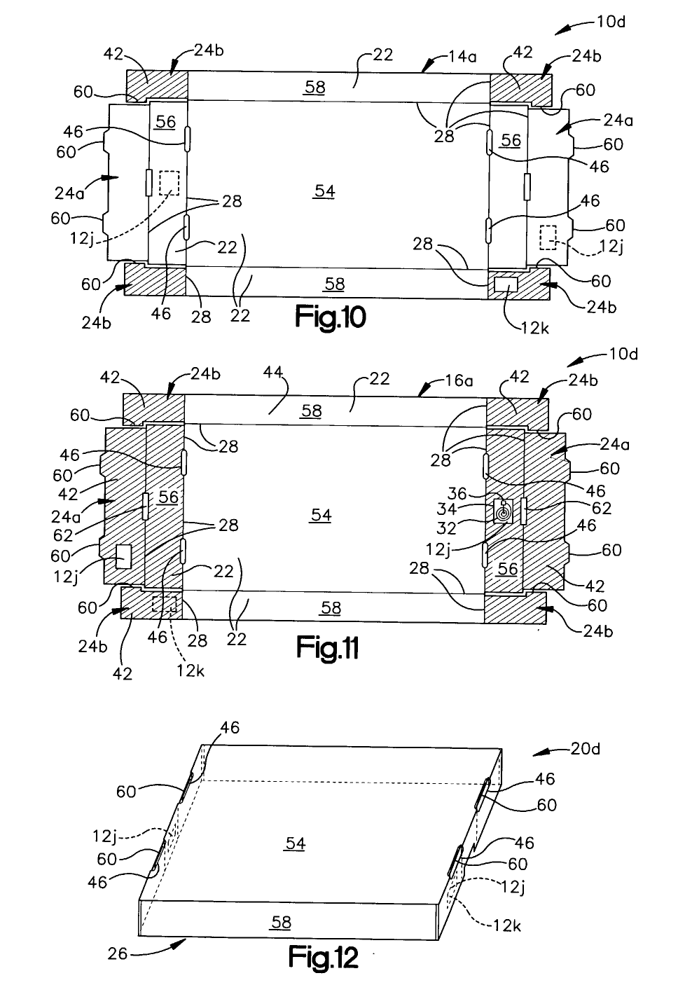

FIGS. 10-12 show a lid 20d for positioning on top of another container. FIG. 10 shows the external surface 14d of the blank 10d, FIG. 11 shows the internal surface 16d of the blank 10d, and FIG. 12 shows the blank 10d after it has been erected into a lid 20d. The blank 10d includes interconnected body panels 22, end flaps 24a, and side flaps 24b, which are separated from one another along score lines 28. The interconnected body panels 22 include a main body panel 54, two end panels 56, and two side panels 58. The end flaps 24a are connected to the end panels 56, and the side flaps 24b are connected to the side panels 24b. The flaps 24a, 24b, 24c and panels 22 are foldable along the score lines 28. The end and side flaps 24a, 24b preferably include tabs 60, which are utilized in erecting the blank 10d into a lid 20d, as will be discussed in greater detail below. A hole 62 may be positioned between the end panels 56 and the end flaps 24a, which is utilized as a hand hold for assisting the user in removing the lid 20d from another container. Slots 46 are also positioned between the main body panel 54 and the end panels 56. These slots 46 are utilized for inserting the tabs 60 from the end and side flaps 24a, 24b to secure the flaps and panels together to construct the lid 20d.

In order to assemble the container blank 10 shown in FIGS. 10 and 11 to form the lid 20d of FIG. 12, the side panels 58 are folded in toward the main body panel 54 along the score lines 58 and the side flaps 24b are folded in toward the end panels 56 so that the side flaps 24b align with the score lines 58 positioned between the end panels 56 and the main body panel 54. The tabs 60 on the side flaps 24b are inserted into the slots 46 positioned between the end panels 56 and the main body panel 54. The end panels 56 are folded inwardly along the score line 58 toward the main body panel 54 so that the internal surfaces 16d of the end panels 56 are positioned adjacent the side flaps 24b. The end flaps 24a are then folded inwardly along the score lines 28 between the end flaps 24a and the end panels 56 over the side flaps 24b. The tabs 60 on the end flaps 24a are inserted into the slots 46, which secures the lid 20d together. The lid 20d may be positioned on an open top container (not shown) and may be secured to the container by tape, staples, glue, or other adhering mediums, if desired.

When the blank 10d is erected, the end and side flaps 24a, 24b overlap one another and several of the panels. The areas 42 where the flaps overlap one another and the panels is shown by cross-hatching in FIGS. 10 and 11. The overlapping areas 42 shown in FIGS. 10 and 11 are typically not visible when the lid 20d is erected.

The RF transponder 12 may be positioned in a number of different locations in the overlapping area 42 shown in FIGS. 10-11. In one embodiment, an RF transponder 12j is positioned on the internal surface 14d of one of the end flaps 24a or one of the end panels 56. In another embodiment, a transponder 12k may be positioned on either the external or internal surfaces 14d, 16d of the side flaps 24b. Since the side flaps 24b are sandwiched between the end flaps 24a and end panels 56 when the lid 20d is erected, positioning the transponder 12k on the side flaps 24b or on the internal surface 16d of the end flaps 24a or end panels 56 will result in covert placement of the transponder 12k when the container 20d is erected.

The RF transponders 12 utilized with the present design may be applied to the container blanks 10 in the form of labels having a pressure sensitive adhesive applied to one side of the labels. Alternatively, a processor and antenna may be positioned on one of the surfaces of the blank without the need for a label or other substrate.

A corrugated structure is typically manufactured using a corrugator, a single facer, a double facer, a dryer, and a cutter, among other parts of the assembly line. The corrugated structure is manufactured by adhering two linerboards to a corrugated medium, which is sandwiched between the linerboards. The corrugated medium is held to the linerboards with an adhesive, which is typically applied to the flutes of the corrugated medium. After the linerboards have been adhered to the corrugated medium using the single and double facers, the corrugated structure enters the drying unit, where the adhesive is dried. The cutter is positioned at the end of the process, after the structure has been dried, and cuts the corrugated structure into individual sheets based upon predetermined sizing requirements. These sheets may be fed into a machine that forms the individual sheets into blanks.

Different types of machines may be utilized in forming the sheets into blanks, such as a Flexo-Folder-Gluer, a Die Cutter, or a Flexo Press. A Flexo-Folder-Gluer slots, scores, prints, glues, folds, stacks, and bundles the container blanks. A Die Cutter cuts, scores, and prints container blanks, but typically does not fold or glue the blanks. A Flexo Press typically prints the container blank. Flexo-Folder-Gluers typically handle one blank at a time. In comparison, Die Cutters are typically capable of handling more than one blank at a time. They accept larger sheets of corrugated material and transform the larger sheets into two or more blanks at once.

The RF transponder 12 is preferably applied to the container blank during the manufacturing process. One way for applying the transponder to a blank is by utilizing a label or other applicator, which applies the substrate 34 to either the external 14 or internal 16 surfaces of the blank 10 during the manufacturing process. The label applicator may be positioned within the machine that is utilized to form the corrugated sheet into a blank 10. Alternatively, the label applicator may be positioned before or after the machine that is utilized to form the corrugated sheet into a blank. An example utilizing a Flexo-Folder-Gluer is described below, the design not being limited to the use of a particular machine. With the Die Cutter, more than one label applicator may be utilized at a time, since the Die Cutter typically forms more than one blank at a time.

With certain types of container blanks, such as those depicted in FIGS. 1-6, the Flexo-Folder-Gluer slots or cuts and scores the corrugated blank and folds and glues the assembly flap 24c to the adjoining panel, before ejecting and stacking the blanks. In one embodiment, a label applicator is positioned between the slotting/die cutting/scoring sections and the folding/gluing section of the machine so that the transponder is positioned on the assembly flap 24c before the assembly flap 24c is adhered to the adjoining panel. In another embodiment, the label applicator is positioned after the folding/gluing section, but before the stacking/ejecting section. The label applicator can position a transponder 12 on the external surface of the blank 10 in one of the overlapping areas on the blank 10 as the blank 10 exits the folding/gluing section. In yet another embodiment, the label applicator is positioned before the feed section, before or during the print section, or before or during the slotting/cutting/scoring section. When placed in any of these locations, the transponder 12 may either be positioned on an internal or external surface of the corrugated blank. In each of the embodiments, the transponder placement must be properly registered so that when the corrugated blank is formed as a finished container blank 10, a single transponder is positioned on each finished container blank 10 in an overlapping area 42, 44.

In a further embodiment, the RF transponder is applied to the corrugated sheet before the sheet enters the Flexo-Folder-Gluer. A stack of corrugated sheets will typically be fed into the Flexo-Folder-Gluer. Before the sheets are fed into the machine, a label applicator and/or feeder may be utilized to apply the labels at predetermined positions that will correspond to the overlapping areas 42, 44 on the sheets. Alternatively, the transponders 12 may be applied before or after the cutter on the corrugator in appropriate locations that will correspond with the overlapping areas 42, 44 formed when the sheet is processed into a container blank 10.

Furthermore, an applicator may be positioned after the Flexo-Folder-Gluer to apply the transponders 12 to the container blanks after they have been stacked. It is preferred that the transponders are automatically applied in the overlapping areas 42, 44 on the blanks. However, they may also be positioned individually by hand or otherwise.

It should be noted that the above description also applies to the embodiments shown in FIGS. 7-12, except for an assembly flap 24c is not adhered to the adjoining panel during container blank 10 formation. With the container shown in FIGS. 7-9, an adhesive may be applied to the adjoining panel during manufacture of the blank 10 and a release paper may be positioned over the adhesive so that the blank 10 may be formed into a container by a user. With the container lid shown in FIGS. 10-12, no assembly flap 24c is provided and no adhering medium is typically necessary to erect the container into a lid. However, an adhering medium may be utilized, if so desired.

While not shown, a recess may be formed in the surface of the container blank 10 in the overlapping area 42, 44. The RF transponder 12 is positioned in the recess. A recess may add to the covert nature of the transponder, since a bulge will not be evident from the exterior of the container. The recess may be formed on the container blank 10 during the manufacturing process, such as by embossing the recess into the blank 10. The embossed region is preferably not visible from the exterior of the erected container.

In the preferred embodiments, examples of which are described and shown in the figures, the RF transponder is passive. However, a semi-passive or active system is also contemplated for use with the present design. If a semi-passive or active transponder is utilized, a battery is coupled to the processor. In addition, a sensor may be electrically coupled to the RF processor on the transponder 12 for communication with the processor, such as a MEMS (micro electromechanical system) sensor. The sensor may be used to read environmental or other conditions in the vicinity of the sensor, such as time, temperature, pressure, and humidity, among other conditions. Multiple sensors may be utilized with a single or multiple RF processors. The sensors may be utilized to read and transmit a signal corresponding to the environmental or other conditions when signaled by an RF reader. Alternatively, the sensors may include a battery which allows the sensor to read and record the conditions, and the recorded data may be transmitted when activated by an RF reader. One type of passive sensor that may be utilized, for example, to read a temperature is manufactured by SCS of San Diego, Calif. A type of active sensor that may be utilized, for example, to record temperature data is manufactured by KSW of Germany. Other types of sensors may also be utilized.

A variety of commercially available processors are contemplated for use with the claimed invention, including both capacitive processors and inductive processors. Some commercially available processors include those manufactured by Phillips, Hitachi, or Texas Instruments, among others.

The container blanks described above may be formed from any of the widely accepted materials used to manufacture such containers including corrugated fiberboard, flat fiberboard, corrugated polymeric and cellulosic fibers, sheets of solid polymeric materials, and the like. The invention is useful with both corrugated and non-corrugated materials.

It will be readily recognized by those of skill in the art that the present invention is not limited to the above-described embodiments. Other types of containers 20 may be utilized with the claimed invention, as long as overlapping areas 42, 44 are provided on the containers. Furthermore, the transponder 12 may be positioned on a container blank 10 in any known way or position in the manufacturing process, as long as the transponder 12 is positioned in one of the overlapping areas 42, 44.

While various features of the claimed invention are presented above, it should be understood that the features may be used singly or in any combination thereof. Therefore, the claimed invention is not to be limited to only the specific embodiments depicted herein.

Further, it should be understood that variations and modifications may occur to those skilled in the art to which the claimed invention pertains. The embodiments described herein are examples of the claimed invention. The disclosure may enable those skilled in the art to make and use embodiments having alternative elements that likewise correspond to the elements of the invention recited in the claims. The intended scope of the invention may thus include other embodiments that do not differ or that insubstantially differ from the literal language of the claims. The scope of the present invention is accordingly defined as set forth in the appended claims.

What is claimed is:

1. An RFID enabled container comprising:
a container blank having a plurality of interconnected panels and a plurality of flaps for use in erecting a container having an opening bounded by the plurality of interconnected panels, said flaps being configured to form the blank into a three-dimensional shape and at least partially close the opening by overlapping one another or said panels, said flaps and panels defining an overlapping area on the blank where the plurality of flaps and panels overlap when the container blank is erected; and
an RF transponder positioned on said blank in the overlapping area such that the transponder is not visible from the exterior of the container when the container blank is erected.

2. The container of claim 1, wherein the RF transponder is positioned so that the RF transponder is not visible from the interior of the container when the container blank is erected.

3. The container of claim 1, wherein the container blank is a corrugated material, and the RF transponder is positioned on an external surface of one of the plurality of flaps.

4. The container of claim 3, wherein the RF transponder is positioned such that an adjacent flap covers the RF transponder when the container is erected.

5. The container of claim 1, wherein the RF transponder is positioned on an internal surface of the blank in the overlapping area.

6. The container of claim 1, wherein the RF transponder is positioned on one of the plurality of interconnected panels.

7. The container of claim 1, wherein the RF transponder is a label having an adhesive layer affixed thereto and the adhesive layer is applied to the container blank in the overlapping area.

8. The container of claim 1, wherein the RF transponder includes an RF processor and an antenna is coupled to the processor.

9. The container of claim 8, wherein the antenna is positioned onboard the processor.

10. The container of claim 8, wherein the antenna is positioned on the transponder and electrically coupled to the RF processor.

11. The container of claim 8, wherein the antenna is positioned on the container blank, and the RF processor of the transponder is electrically coupled to the antenna.

12. The container of claim 1, further comprising an adhering medium coupled to at least some of said plurality of flaps for adhering the flaps to one another or the panels to erect the container.

13. The container of claim 12, wherein the adhering medium is at least one of an adhesive, a tape, or a staple.

14. The container of claim 1, wherein the plurality of flaps includes an assembly flap, a plurality of end flaps, and a plurality of side flaps, with the assembly flap being configured to couple to an adjoining panel that is one of the plurality of interconnecting panels to form the three-dimensional shape surrounding the opening, the end flaps being foldable into the opening, and the side flaps being foldable into the opening over the end flaps.

15. The container of claim 14, wherein an adhesive is positioned between the assembly flap and the adjoining panel, and between the end flaps and side flaps.

16. The container of claim 14, wherein the plurality of end flaps include bottom end flaps, the plurality of side flaps include bottom side flaps, and an adhesive is positioned between the assembly flap and the adjoining panel, and between the bottom end flaps and bottom side flaps to erect a container.

17. The container of claim 1, wherein the container is a lid and the plurality of panels on the container blank include a body panel, two side panels, and two end panels, and the plurality of flaps on the container blank include two end flaps, each of which is attached to one of the end panels, and four side flaps, two of which are attached to each of the side panels, wherein the two end flaps are configured to fold over the respective end panels, and the four side flaps are configured to be positioned between the end panels and the end flaps when the container blank is erected, wherein the overlapping area is defined on the side flaps, end flaps, and end panels.

18. The container of claim 1, further comprising a sensor coupled to said RF transponder for communication of a condition to the transponder.

19. A method of forming an RFID enabled container comprising:
providing a container blank having a plurality of interconnected panels and a plurality of flaps for erecting a container having an opening bounded by the plurality of interconnected panels, the flaps being configured to form the blank into a three-dimensional shape and at least partially close the opening by overlapping at least one of the flaps and the panels, said flaps and panels defining an overlapping area on the blank where the plurality of flaps and panels overlap when the container is erected; and
coupling an RF transponder to the blank in the overlapping area.

20. The method of claim 19, further comprising:
erecting the container by folding and attaching the flaps of the blank to at least partially cover the opening.

21. The method of claim 19, wherein the blank has an internal and an external surface, and the coupling the transponder step includes positioning the RF transponder on one of the external surface or the internal surface of one of said plurality of flaps.

22. The method of claim 21, wherein the coupling the transponder step includes positioning the RF transponder on the internal surface so that when the blank is erected, the RF transponder is not visible.

23. The method of claim 19, wherein the blank has an internal and an external surface, and the coupling the transponder step includes positioning the RF transponder on the external surface of one of the flaps or panels.

24. The method of claim 19, wherein the providing step includes forming a container blank, the forming step comprising:
providing a corrugated structure;
cutting the corrugated structure into a blank having a plurality of panels and a plurality of flaps; and
scoring the corrugated structure to form score lines between the plurality of panels and flaps.

25. The method of claim 19, wherein the RF transponder includes a substrate having an adhesive surface and the positioning step includes applying the adhesive surface of the substrate to the blank in the overlapping area.

26. The method of claim 20, further comprising applying an adhering medium to the flaps and the erecting step includes attaching the flaps to one another and the respective panels with the adhering medium.

27. The method of claim 19, wherein the RF transponder comprises an RF processor, and further comprising coupling an antenna to the RF processor.

28. The method of claim 27, wherein the coupling the antenna step comprises positioning the antenna on the RF transponder in electrical association with the RF processor.

29. The method of claim 27, wherein the coupling the antenna step comprises positioning the antenna on the blank and positioning the transponder in association with the antenna so that the RF processor is electrically connected to the antenna.

30. The method of claim 19, wherein the plurality of flaps comprises a plurality of end flaps, a plurality of side flaps, and an assembly flap, and the providing step further comprises connecting the assembly flap to one of the plurality of interconnected panels, and coupling the end flaps to the side flaps to close the opening.

31. The method of claim 30, wherein the connecting step comprises adhering the assembly flap to the respective panel with an adhering medium, and the coupling the end flaps to the side flaps step comprises adhering the end flaps to the side flaps with an adhering medium, wherein the adhering medium comprises one of an adhesive, a plurality of staples, or a tape.

32. The method of claim 19, further comprising coupling a sensor to the RF transponder for recording a condition and communicating the condition to the transponder.
